(19) United States
(12) Patent Application Publication
(10) Pub. No.: US 2026/0065824 A1
(43) Pub. Date: Mar. 5, 2026

(54) Display Strain Aware Frame Insertion Frame Rate Sequencing

(71) Applicant: Apple Inc., Cupertino, CA (US)

(72) Inventors: Jongyup Lim, San Jose, CA (US); Jonathan E. Loh, San Jose, CA (US); Koorosh Aflatooni, Los Altos Hills, CA (US); Jie Won Ryu, San Jose, CA (US); Hyunwoo Nho, Palo Alto, CA (US); Peter F. Holland, Los Gatos, CA (US); Kyounghwan Kim, San Jose, CA (US)

(21) Appl. No.: 19/316,424

(22) Filed: Sep. 2, 2025

Related U.S. Application Data
(60) Provisional application No. 63/690,290, filed on Sep. 3, 2024.

(51) Int. Cl. G09G 3/00; G06F 3/147; G09G 3/3225

(52) U.S. Cl. CPC G09G 3/035; G09G 3/3225; G06F 3/147; G09G 2320/0233; G09G 2320/0247; G09G 2340/0435

(57) ABSTRACT

An electronic device may include an electronic display to display frames of image data and processing circuitry to determine a display strain transition event of the electronic display and change a refresh rate of the electronic display based on the determination of the display strain transition event. The electronic device may temporarily increase the refresh rate based on determining that the display strain transition event includes folding or unfolding the electronic display. The electronic device may sequence down the refresh rate to a lower refresh rate after a period of time. As such, perceivable image artifacts in displayed image content caused by folding or unfolding the electronic display may be reduced or eliminated.

### CROSS-REFERENCE TO RELATED APPLICATIONS

This application claims priority to U.S. Provisional Application No. 63/690,290, entitled “Display Strain Aware Frame Insertion Frame Rate Sequencing,” filed Sep. 3, 2024, which is incorporated by reference herein in its entirety.

### SUMMARY

The present disclosure relates generally to systems and methods for luminance compensation for a foldable display to mitigate image artifacts due to display strain magnitude change during folding event and/or an unfolding event.

A summary of certain embodiments disclosed herein is set forth below. It should be understood that these aspects are presented to provide the reader with a brief summary of these certain embodiments and that these aspects are not intended to limit the scope of this disclosure.

Electronic displays may be found in numerous electronic devices, from mobile phones to computers, televisions, automobile dashboards, and augmented reality or virtual reality glasses, to name just a few. Electronic displays may display a frame of image content for a period of time, then display a subsequent frame of image content for the period of time. A frequency at which image content is replaced or refreshed is referred to as a “refresh rate.” In certain instances, a higher refresh rate may correspond to a smoother transition between image content since frames of image content are replaced at a higher frequency, while a lower refresh rate may correspond to a lower frequency at which image content may be replaced, which may reduce power consumption of the electronic display.

In certain instances, the electronic displays may take the form of a foldable display that may fold or roll up to take a variety of shapes. For example, some foldable displays may include a hinged region where two areas (e.g., portions) of the foldable display may fold inwards and/or outwards. The foldable displays may be in different states, such as a fully folded state, a partially folded state, a partially unfolded state, a fully unfolded state, and so on. For example, during operation, the foldable displays may undergo an “unfolding event” that may include a transition between a fully folded state to a fully unfolded state, or a partially folded state to a fully unfolded state, a partially folded state to a partially unfolded state. In another example, the foldable displays may undergo a “folding event” that may include a transition between a fully unfolded state to a fully folded state, a partially unfolded state to a fully folded state, or a partially unfolded state to a partially unfolded state. The folding event and unfolding event may be collectively referred to herein as a “display strain transition event.”

The foldable displays may display image content at any suitable refresh rate (e.g., first refresh rate). In certain instances, the foldable display may implement a low refresh rate (e.g., extended blanking of the foldable display) when displaying image content that may not be rapidly changing and/or when utilizing a power saving mode. However, during a display strain transition event, the threshold voltage of one or more transistors within the foldable display may shift, thereby changing an amount of current provided to the light-emitting diode. As such, the self-emission display pixels may emit less light and the image content displayed on the foldable display may include perceivable image artifacts, such as brightness variations and/or luminance glitches.

Accordingly, the present disclosure is directed to a frame rate insertion and sequencing technique for temporarily increasing the refresh rate of the foldable display in response to detecting a display strain transition event to reduce or eliminate perceivable image artifacts. For example, in response to detecting an unfolding event, the electronic device may insert one or more frames of image content to temporarily increase the refresh rate (e.g., second refresh rate) over a period of time. After the period of time, the electronic device may slowly sequence down to a refresh rate (e.g., third refresh rate) less than the increased refresh rate. The temporarily increased refresh rate may be sufficient to compensate for the shifting threshold voltage of the transistors, thereby reducing the brightness variations and/or luminance glitches to a level beneath human perception.

### BRIEF DESCRIPTION OF THE DRA WINGS

Various aspects of this disclosure may be better understood upon reading the following detailed description and upon reference to the drawings in which:

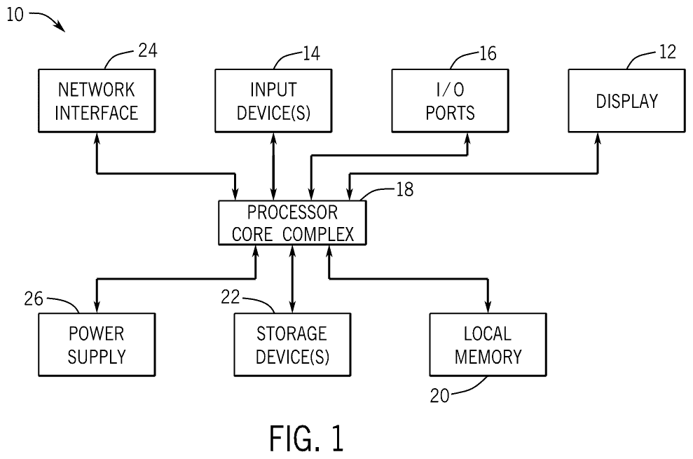

FIG. 1 is a block diagram of an electronic device that includes an electronic display, in accordance with an embodiment;

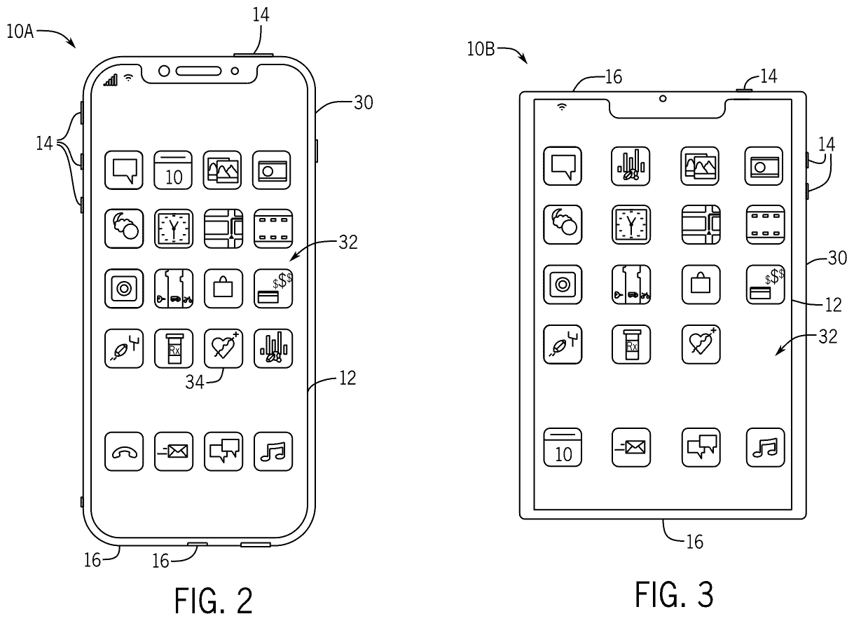

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

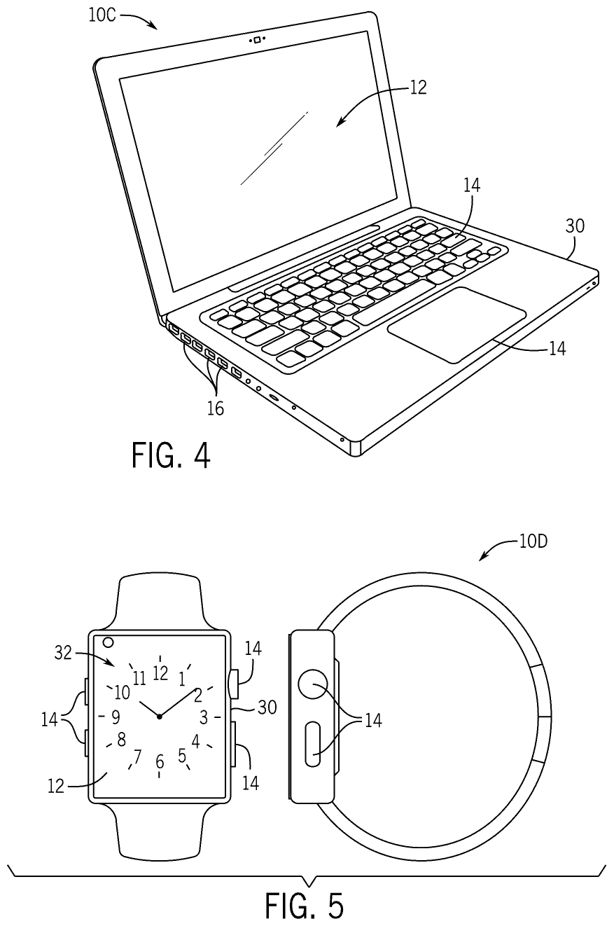

FIG. 4 is another example of the electronic device of FIG. 1 in the form of a computer, in accordance with an embodiment;

FIG. 5 is another example of the electronic device of FIG. 1 in the form of a watch, in accordance with an embodiment;

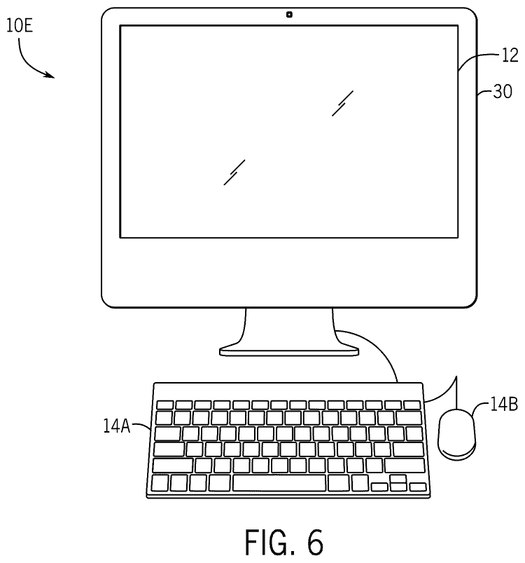

FIG. 6 is another example of the electronic device of FIG. 1 in the form of a computer, in accordance with an embodiment;

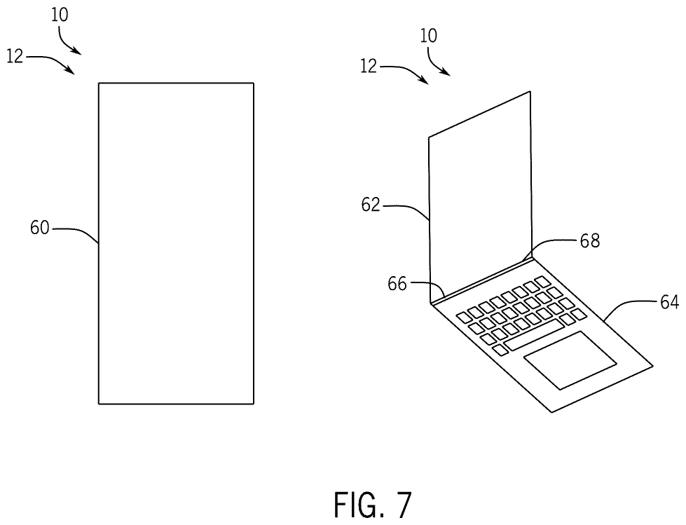

FIG. 7 is an unfolded view and folded view of the electronic device of FIG. 1, in accordance with an embodiment;

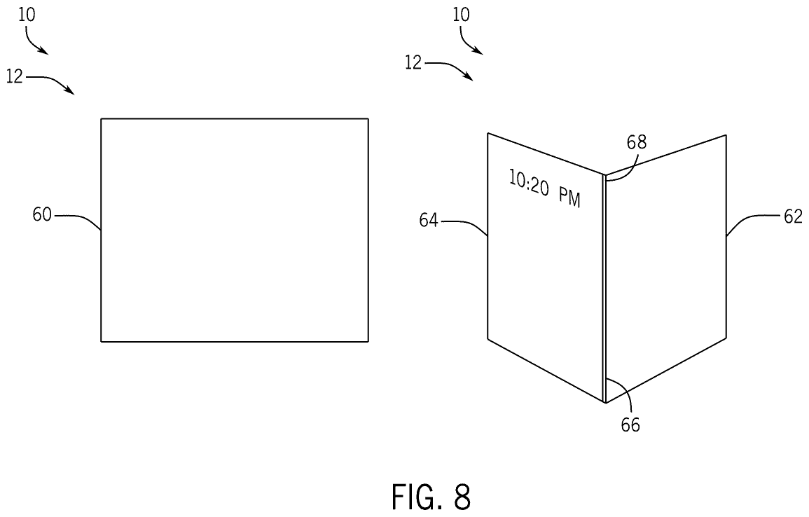

FIG. 8 is another unfolded view and folded view of the electronic device of FIG. 1, in accordance with an embodiment;

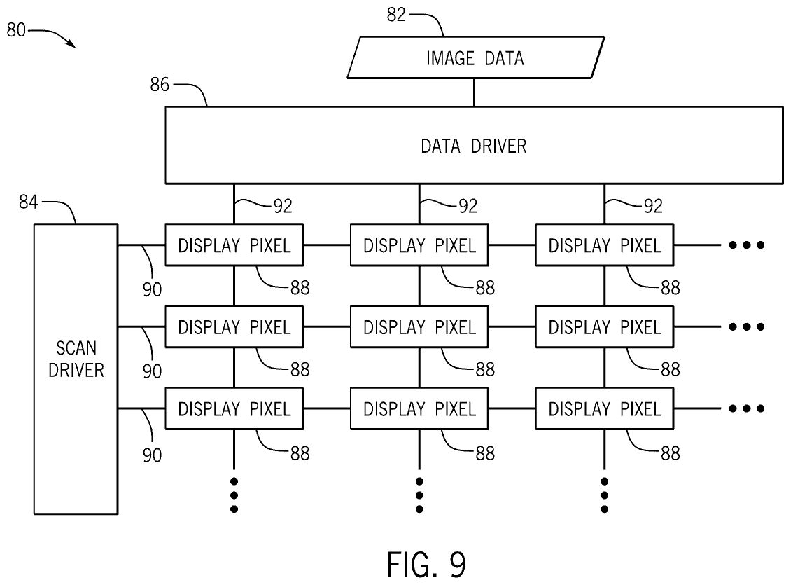

FIG. 9 is a block diagram of display driver circuitry of the electronic display of FIG. 1, in accordance with an embodiment;

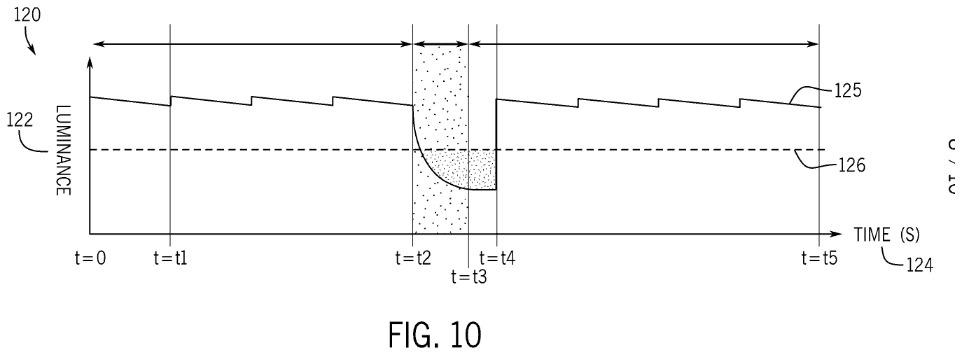

FIG. 10 depicts a timing diagram of display multiple frames of image content on the electronic device of FIG. 1, in accordance with an embodiment;

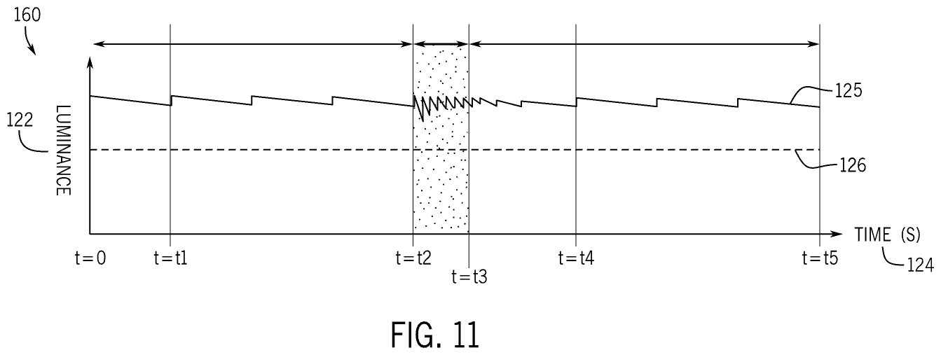

FIG. 11 depicts a timing diagram of displaying multiple frames of image content on the electronic device of FIG. 1 using a frame insertion and sequencing technique, in accordance with an embodiment; and

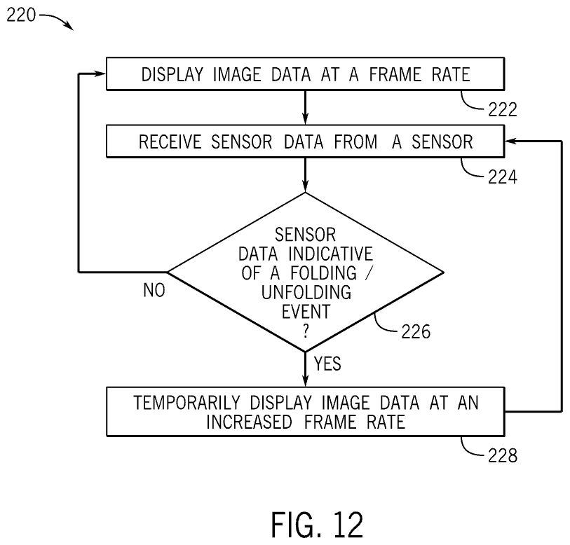

FIG. 12 is a flowchart of an example method for displaying image data on the electronic device of FIG. 1 using the frame insertion and sequencing technique, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “one embodiment,” “an embodiment,” “embodiments,” and “some embodiments” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Many electronic devices may use display panels to show image content to users. User display panels may be pixel-based panels including self-emissive elements, such as light-emitting diode (LED) panels, organic light-emitting diodes (OLED) panels and/or plasma panels. As discussed herein, the self-emissive elements may include one or more transistors (e.g., driving transistors) coupled to an LED in the case of LED panels or one or more transistors coupled to an OLED in the case of OLED panels. The transistors may have a threshold voltage that may be a minimum voltage at which the respective transistor starts to turn on and facilitate current flow. The transistors may control an amount of current flowing to and/or through the respective LED or OLED, thereby driving the LED or OLED to emit light. The brightness (e.g., luminance, intensity) of light emitted by the LED or OLED may be determined by the amount of current flow to and/or through the respective LED or OLED. By way of example, display pixels with OLEDs may include a single time in-pixel voltage compensation per frame in order to generate an accurate emission current.

In certain instances, the display panels may include a foldable display that may be folded and/or unfolded about a hinge of the electronic device. The electronic device may include display driver circuitry to program display pixels of the foldable display with data signals (e.g., image data) indicative of image content. For example, the image content may include multiple frames that can be displayed and refreshed over a period of time. By way of example, a 60 Hertz (Hz) display may refresh, and/or update the image content, 60 times per second. In certain instances, the image content may be displayed for an extended period of time or the image content may not substantially change from frame to frame. As such, it may be beneficial to operate in a low refresh rate mode to save power. For example, operating in a low refresh mode, the electronic device may operate using a refresh rate (e.g., low refresh rate) of 1 Hz, 5 Hz, 10 Hz, and so on. In the low refresh mode, the display driver circuitry may program the display pixels less frequently and/or the display panel may refresh less frequently, resulting in increased susceptibility to luminance changes, and the like.

Additionally or alternatively, when the foldable display transitions from a folded state to an unfolded state, portions of the foldable display proximate to a hinge may display image content with perceivable image artifacts. For example, image content displayed within the portions may appear brighter or darker than intended in comparison to target luminance levels of the image data programmed into the corresponding display pixels. For example, a strain magnitude and/or profile of the transistors may vary and cause the respective threshold voltage to shift and cause a luminance glitch and/or brightness variation in the light emitted by the display pixels. In the low refresh mode, if there may be an intra-frame threshold voltage shift after the voltage compensation (e.g., in-pixel compensation of voltage), then the emission current level may shift. As such, the image content displayed may include portions that may appear brighter or darker than intended. Similarly, when the foldable display transitions from an unfolded state to a folded state, the portions proximate to the hinge may display image content with perceivable image artifacts. In other words, the foldable display may display image content with perceivable image artifacts when undergoing a display strain transition event.

Embodiments described herein are related to systems and techniques for panel glitch (e.g., front of screen error, image artifacts) prevention during a display strain transition event. More specifically, the present disclosure discusses temporarily increasing the refresh rate for a period of time and sequencing down to a lower refresh rate to reduce or eliminate perceivable image artifacts.

To help illustrate, an example of an electronic device 10, which includes and/or utilizes an electronic display 12, is shown in FIG. 1. As will be described in more detail below, the electronic device 10 may be any suitable electronic device, such as a computer, a mobile (e.g., portable) phone, a portable media device, a tablet device, a television, a handheld game platform, a personal data organizer, a virtual-reality headset, a mixed-reality headset, a vehicle dashboard, and/or the like. Thus, it should be noted that FIG. 1 is merely one example of a particular implementation and is intended to illustrate the types of components that may be present in an electronic device 10.

The electronic device 10 may include one or more electronic displays 12, input devices 14, input/output (I/O) ports 16, a processor core complex 18 having one or more processors or processor cores, local memory 20, a main memory storage device 22, a network interface 24, and a power source 26. The various components described in FIG. 1 may include hardware elements (e.g., circuitry), software elements (e.g., a tangible, non-transitory computer-readable medium storing instructions), or a combination of both hardware and software elements. As should be appreciated, the various components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth® network, a local area network (LAN), such as an 802.11x Wi-Fi network, or a wide area network (WAN), such as a 4G, Long-Term Evolution (LTE), or 5G cellular network.

The power source 26 may provide electrical power to operate the processor core complex 18 and/or other components in the electronic device 10. Thus, the power source 26 may include any suitable source of energy, such as a rechargeable lithium polymer (Li-poly) battery and/or an alternating current (AC) power converter.

The I/O ports 16 may enable the electronic device 10 to interface with various other electronic devices. The input devices 14 may enable a user to interact with the electronic device 10. For example, the input devices 14 may include buttons, keyboards, mice, trackpads, and the like. Additionally or alternatively, the electronic display 12 may include touch-sensing components that enable user inputs to the electronic device 10 by detecting the occurrence and/or position of an object touching its screen (e.g., surface of the electronic display 12).

The electronic display 12 may display a graphical user interface (GUI) (e.g., of an operating system or computer program), an application interface, text, a still image, and/or video content. The electronic display 12 may include a display panel with one or more display pixels to facilitate displaying images. Additionally, each display pixel may represent one of the sub-pixels that control the luminance of a color component (e.g., red, green, or blue). Although sometimes used to refer to a collection of sub-pixels (e.g., red, green, and blue subpixels), as used herein, the terms display pixel or pixel may refer to an individual sub-pixel (e.g., red, green, or blue subpixel).

As described above, the electronic display 12 may display an image by controlling the luminance output (e.g., light emission) of the sub-pixels based on corresponding image data. In some embodiments, pixel or image data may be generated by an image source, such as the processor core complex 18, a graphics processing unit (GPU), or an image sensor (e.g., camera). Additionally, in some embodiments, image data may be received from another electronic device 10, for example, via the network interface 24 and/or an I/O port 16. Moreover, in some embodiments, the electronic device 10 may include multiple electronic displays 12 and/or may perform image processing (e.g., via the processor core complex 18) for one or more external electronic displays 12, such as connected via the network interface 24 and/or the I/O ports 16.

The electronic device 10 may be any suitable electronic device. To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For illustrative purposes, the handheld device 10A may be a smartphone, such as an iPhone® model available from Apple Inc.

The handheld device 10A may include an enclosure 30 (e.g., housing) to, for example, protect interior components from physical damage and/or shield them from electromagnetic interference. The enclosure 30 may surround, at least partially, the electronic display 12. In the depicted embodiment, the electronic display 12 is displaying a graphical user interface (GUI) 32 having an array of icons 34. By way of example, when an icon 34 is selected either by an input device 14 or a touch-sensing component of the electronic display 12, an application program may launch.

Input devices 14 may be accessed through openings in the enclosure 30. Moreover, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. Moreover, the I/O ports 16 may also open through the enclosure 30. Additionally, the electronic device 10 may include one or more cameras to capture pictures or video. In some embodiments, a camera may be used in conjunction with a virtual reality or augmented reality visualization on the electronic display 12.

Another example of a suitable electronic device 10, specifically a tablet device 10B, is shown in FIG. 3. The tablet device 10B may be any iPad® model available from Apple Inc. A further example of a suitable electronic device 10, specifically a computer 10C (e.g., notebook computer), is shown in FIG. 4. By way of example, the computer 10C may be any MacBook® model available from Apple Inc. Another example of a suitable electronic device 10 (e.g., a worn device), specifically a watch 10D, is shown in FIG. 5. By way of example, the watch 10D may be any Apple Watch® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed with respect to FIGS. 2 and 3.

Turning to FIG. 6, a computer 10E may represent another embodiment of the electronic device 10 of FIG. 1. The computer 10E may be any suitable computer, such as a desktop computer or a server, but may also be a standalone media player or video gaming machine. By way of example, the computer 10E may be an iMac® or other device by Apple Inc. of Cupertino, California. It should be noted that the computer 10E may also represent a personal computer (PC) by another manufacturer. A similar enclosure 30 may be provided to protect and enclose internal components of the computer 10E, such as the electronic display 12. In certain embodiments, a user of the computer 10E may interact with the computer 10E using various peripheral input devices 14, such as a keyboard 14A or mouse 14B, which may connect to the computer 10E.

The electronic display 12 may include a foldable electronic display 12, depicted in FIG. 7. The foldable electronic display 12 may be folded an unfolded state 60 (referred to herein as a “fully unfolded state”) or folded inwardly into a top half 62 and a bottom half 64 (referred to herein as a “partially unfolded state” or a “partially folded state”). Although not illustrated, the foldable electronic display 12 may be in a “fully folded state” in which the top half 62 may be adjacent to the bottom half 64. For example, in the fully folded state, the top half 62 may be positioned flush against the bottom half 64.

When the foldable electronic display 12 is folded inwardly, a top half 62 of the foldable electronic display 12 may function to display media content (e.g., games, articles, videos, messages) that a viewer (e.g., user) may desire to view on the electronic device 10. A bottom half 64 of the foldable electronic display 12, when folded inwardly, may function as an input medium (e.g., keyboard, keypad, dial pad) for the electronic device 10. The ability for the bottom half 64 to function as an input medium enables for expanded functionality of the electronic device 10. As discussed above, the foldable electronic display 12 may include one or more folds, such that the folded sections may be equal in area and/or different in area. The embodiments described below demonstrate a single fold display including the top half 62 folded section and the bottom half 64 folded section, but other embodiments may include the multiple fold display that enables folding at one or more folds and/or a flexible fold display (e.g., rollable display) that may be designed to bend and/or roll at one or more portions of the foldable electronic display 12.

To detect a state of the foldable electronic display 12, the electronic device 10 may include a sensor 66 to detect movement (e.g., motion) of the top half 62, the bottom half 64, or both. For example, the sensor 66 may generate sensor data indicative of an angle (e.g., folding angle), angular velocity, angular momentum, linear movement, and the like. For example, the sensor 66 may generate sensor data indicative of angular movement of the top half 62 and/or the bottom half 64 about the hinge, linear movement of the top half 62 and/or the bottom half, and the like. As illustrated, the sensor 66 may be positioned within a hinge 68 of the foldable electronic display 12 and detect angular movement of the top half 62 and/or the bottom half 64 about the hinge 68. In another example, the sensor 66 may be positioned within the top half 62, the bottom half 64, or both, and detect movement of the top half 62, the bottom half 64, or both during the display strain transition event. The sensor 66 may include a motion sensor, a gyroscope, an angular sensor, or any suitable type of sensor for detecting linear movement, angular movement, rotation, and the like. It may be appreciated that the sensor 66 may include any suitable number of sensors and/or suitable type of sensor. For example, a first sensor 66 may be positioned within the top half 62, a second sensor 66 may be positioned within the bottom half 64, and/or a third sensor 66 may be positioned within the hinge.

As illustrated in FIG. 7, the foldable electronic display 12 is folded inward, the top half 62 may display image content (e.g., media content), and the bottom half 64 may function as an input medium such as a keyboard. When the foldable electronic display 12 is in the unfolded state 60, the brightness setting may be constant for the entire foldable electronic display 12. For example, the foldable electronic display 12 may use a lower refresh rate in the unfolded state 60 when the image data is constant and the foldable electronic display 12 may increase the refresh rate to a higher refresh rate when the image data is changing.

In addition to the inwardly folding embodiment of FIG. 7, the foldable electronic display 12 may also enable an outwardly folding embodiment as depicted in FIG. 8. In the case of an outwardly folding electronic display 12, the top half 62 of the foldable electronic display 12 may display media content and the bottom half 64 of the foldable electronic display 12 may display a device logo or other minimal information (e.g., time, date, notifications, device wallpaper). Similar to the inwardly folding embodiment detailed above in FIG. 7, the outwardly folding embodiment, when in an unfolded state 60, may apply a constant brightness setting to the entire display. This constant brightness setting may be used in the unfolded state 60 to ensure the content appears to be uniform.

FIG. 9 is a block diagram of display driver circuitry 80 of the foldable electronic display 12. It should be understood that, in an actual implementation, additional or fewer components may be included in the display driver circuitry 80. The foldable electronic display 12 may receive image data 82 for presentation on the foldable electronic display 12. The image data may include compensated image data prepared by processing circuitry (e.g., image processing circuitry within the processor core complex 18) or uncompensated image data. The foldable electronic display 12 may include display driver circuitry 80 that includes scan driver circuitry 84 and data driver circuitry 86. The display driver circuitry 80 may control programming of the image data 82 into the display pixels 88 for presentation of a frame of image content via light emitted by the display pixels 88. The frame of image content may be displayed based on each respective bit of the image data 82 programmed into the display pixels 88.

The display pixels 88 may each include one or more self-emissive elements, such as a light-emitting diodes (LEDs) (e.g., organic light emitting diodes (OLEDs) or micro-LEDs (μLEDs)); however, other pixels may be used with the systems and methods described herein including, but not limited to, liquid-crystal devices (LCDs), digital mirror devices (DMD), or the like, and may include different driving methods than those described herein, including partial image frame presentation modes, variable refresh rate modes, or the like. For example, the display pixels 88 may include respective OLEDs controlled by one or more transistors. The transistor(s) may control an amount of current flowing to and/or through the OLED, which may determine the brightness of the light emitted by the display pixel 88.

Different display pixels 88 may emit different colors. For example, some of the display pixels 88 may emit red light, some may emit green light, and some may emit blue light. Thus, the display pixels 88 may be driven to emit light at different brightness levels to cause a user viewing the electronic display 12 to perceive an image formed from different colors of light. The display pixels 88 may also correspond to hue and/or luminance levels of a color to be emitted and/or to alternative color combinations, such as combinations that use red (R), green (G), blue (B), or others.

The scan driver circuitry 84 may provide scan signals (e.g., pixel reset, data enable, on-bias stress) on scan lines 90 to control the display pixels 88 by row. For example, the scan driver circuitry 84 may cause a row of the display pixels 88 to become enabled to receive a portion of the image data 82 from data lines 92 from the data driver circuitry 86. As such, an image frame of the image data 82 may be programmed onto the display pixels 88 row-by-row. Other examples of the foldable electronic display 12 may program the display pixels 88 in groups other than by row.

FIG. 10 depicts a timing diagram 120 of displaying multiple frames of image content on the electronic device 10. To generate a frame of image content, the display pixels 88 may be programmed with image data 82. The timing diagram 120 illustrates luminance 122 (e.g., of the foldable electronic display 12) over time 124 as the foldable electronic display 12 displays multiple frames of image content. For example, the timing diagram 120 includes a line 125 illustrating the luminance of each frame of image content displayed by the foldable electronic display 12. The electronic display 12 may display a first frame of image content between time t=0 to t=t1 as illustrated by the line 125. In certain instances, the light emitted by display pixels 88 to display the first frame of image content may decrease in luminance 122 over time. With respect to the first frame of image content, the foldable electronic display 12 may display a first luminance at time t=0 and a second luminance at time t=t1 as illustrated by the line 125. The second luminance may be less than the first luminance due. In certain instances, the luminance of the display pixel 88 may stabilize to a static luminance over time.

The foldable electronic display 12 may adjust the luminance when refreshing the image content. For example, the luminance 122 may increase at the beginning of each frame of image content and decay over time. With respect to the timing diagram 120, each new frame of image content may be indicated by an increase in luminance 122. The decrease in luminance 122 over time 124 may not be visible to the viewer if the luminance change is below a threshold luminance change detectable by the viewer. As illustrated, the foldable electronic display 12 may display three additional frames of image content between time t=t1 to t2. The foldable electronic display 12 may display the image content using any suitable refresh rate sufficient. In certain instances, the foldable electronic display 12 may display the image content using a low refresh rate, such as when image content remains the same or similar, which may reduce power consumption. In other instances, the foldable electronic display 12 may maintain the refresh rate during an initial state, such as between time t=t0 to t1. The initial state may include a partially folded state, a fully folded state, a partially unfolded state or a fully unfolded state.

With the foregoing in mind, the timing diagram 120 includes a line 126 depicting a luminance threshold corresponding to human (e.g., the viewer) eye perception threshold. For example, a luminance change crossing (e.g., intersecting) the line 126 may be detectable by the viewer as perceivable image artifacts and/or front of screen errors. For example, the viewer may perceive luminance changes of 1% or greater. As such, a luminance change that crosses the line 126 may illustrate a luminance change of 1% or greater. Changes in luminance 122 below the threshold may be indicative of luminance changes that may not be detectable by the viewer.

As discussed herein, the threshold voltage of the transistors driving the display pixels 88 may shift during a display strain transition event. The display strain transition event may occur during time t=t2 to t3. At time t=t2, a new frame of image data may be programmed into the display pixels 88 and the foldable electronic display 12 may undergo a display strain transition event. During the display strain transition event, the threshold voltage of the transistors may shift, which may cause a shift of emission current level. In other words, the amount of current driving the self-emissive elements to emit light may shift. As such, the luminance 122 of the foldable electronic display 12 may change by an amount detectable by the viewer. As illustrated by the line 125, the luminance of the image content displayed by the foldable electronic display 12 at time t=t2 may decrease, intersect with the line 126, and drop below the line 126, which may indicate that the luminance change may be perceived by the viewer. In other words, the timing diagram 120 illustrates the line 125 dropping below the line 126 at time t=t2, which illustrates a luminance change perceivable by the viewer. The viewer may view perceivable image artifacts within the image content displayed on the foldable electronic display 12 during the display strain transition event due to a shift in the threshold voltage of the transistors within the electronic device 10 within a single frame period. If the threshold voltage shifts, the amount of current provided to the self-emissive element may also change and cause brightness variations and/or flickers to be displayed within the image content on the foldable electronic display 12.

The luminance 122 of the foldable electronic display 12 may change in response to a new frame of image content being displayed on the foldable electronic display 12. At time t=t4, the display strain transition event may be completed and a new frame of image content may be displayed on the foldable electronic display 12. In other words, the foldable electronic display 12 may be in a partially folded state, a fully folded state, a partially unfolded state, and/or a fully unfolded state. The threshold voltage of the display pixels 88 may be constant and the transistors may drive the self-emissive elements to emit light based on the image data. As such, the image content may be displayed without perceivable image artifacts.

As illustrated in the timing diagram 120, the luminance 122 at time t=t4 may be equivalent to the first luminance displayed at time t=t0 and the luminance 122 at time t=t5 may be equivalent to the second luminance displayed at time t=t1. It may be understood that the luminance 122 at time t=t4 may be any suitable luminance level.

To reduce or eliminate perceivable image artifacts during a display strain transition event, it may be beneficial to temporarily increase the refresh rate of the foldable electronic display 12. For example, the foldable electronic display 12 may implement (via image processing circuitry within the processor core complex 18) a frame rate sequencing technique to reduce or eliminate perceivable image artifacts during a display strain transition event. With the foregoing in mind, FIG. 11 depicts a timing diagram 160 of displaying multiple frames of image content on the electronic device 10 using a frame insertion and/or frame rate sequencing technique. As illustrated, the foldable electronic display 12 may temporarily increase the refresh rate during a display strain transition event to maintain a luminance 122 above the luminance threshold (e.g., line 126) to reduce or eliminate perceivable image artifacts.

As illustrated by a line 125, between time t=0 to time t=t2, the foldable electronic display 12 may be in an initial state and display image content at a refresh rate, which may include any suitable refresh rate. Prior to time t=t2, the electronic device 10 may detect (e.g., determine) a display strain transition event and transmit an indication to the foldable electronic display 12. In response to detecting the display strain transition event, the foldable electronic display 12 may implement the frame insertion technique. For example, the foldable electronic display 12 may insert multiple frames of image content, and thus, display multiple frames of image content between time t=t2 and time t=3. In other words, the foldable electronic display 12 may increase the refresh rate over a period of time. As illustrated in the timing diagram 160, the foldable electronic display 12 may display seven frames of image content, which is more than the one frame of image content displayed by the foldable electronic display 12 of FIG. 10 during the same period of time. Each frame of image content (e.g., inserted frame) is indicated by a change in luminance 122. By temporarily increasing the refresh rate, the luminance 122 of the image content displayed by the foldable electronic display 12 between time t=t2 to t=t3 may not cross the line 126, which may indicate that the viewer may not see perceivable image artifacts within the image content. For example, the line 125 illustrating the luminance of the image content displayed on the foldable electronic display 12 does not drop below the line 126. In this way, the foldable electronic display 12 may reduce or eliminate perceivable image artifacts by temporarily increasing the refresh rate based on detection of a display strain transition event.

After the display strain transition event, the foldable electronic display 12 may sequence the refresh rate down from the temporarily increased refresh rate to a lower refresh rate referred to as a “walkdown.” For example, the foldable electronic display 12 may sequence down to a lower refresh rate after completion of the display strain transition event. As illustrated in the timing diagram 160, the number of frames of image content between time t=t3 and t4 may be less than the number of frames of image content during time t=t2 and t3. For example, the foldable electronic display 12 may display four frames of image content between time t=t3 and t4, which is less than the seven frames of image content displayed between time t=t2 and t3. Additionally or alternatively, the refresh rate for display of each frame of image content may be different during the walkdown. For example, a first frame of image content at time t=t4 may be displayed with a higher refresh rate than a subsequent frame of image content on the foldable electronic display 12. The refresh rate may decrease over a number of frames of image content. For example, the increased refresh rate may be sequenced down to a lower refresh rate used between time t=t4 and time t=t5. The refresh rate between time t=t4 and t5 may include any suitable refresh rate, which may be higher than, lower than, or similar to the refresh rate between time t=0 and t1. As illustrated in the timing diagram 160, the refresh rate used during time t=t4 to time t=t5 may correspond to the refresh rate used during time t=0 to time t=t1.

FIG. 12 is a flowchart of an example method 220 for displaying image data on the electronic device 10 using the frame insertion and frame sequencing technique. While the process of FIG. 12 is described using process blocks in a specific sequence, it should be understood that the present disclosure contemplates that the described process blocks may be performed in different sequences than the sequence illustrated, and certain described process blocks may be skipped or not performed altogether. The method 220 may be performed by any suitable processing circuitry (e.g., processor core complex 18, image processing circuitry, display driver circuitry 80) within the electronic device 10.

At block 222, image content may be displayed at a refresh rate. The foldable electronic display 12 may be in an initial state. The processing circuitry within the electronic device 10 may determine and/or update a refresh rate for displaying the image content. The processing circuitry may program image data 82 into the display pixels 88 based on a refresh rate and the foldable electronic display 12 may display the image content using a first refresh rate. For example, the first refresh rate may be a low refresh rate, such as 1 Hz, 5 Hz, 10 Hz, and so on. In another example, the first refresh rate may be any suitable refresh rate, such as 30 Hz, 60 Hz, 90 Hz, 120 Hz, 240 Hz, and so on.

At block 224, sensor data may be received from a sensor 66. The sensor data may include an indication of movement of the foldable electronic display 12. For example, the sensor 66 may generate an indication of an angle and/or an angular velocity. If the foldable electronic display 12 is being folded and/or unfolded, then the indication may include an angle and/or an angular velocity greater than zero. If the foldable electronic display 12 is not being folded and/or unfolded, then the indication may include an angle equal to zero and/or an angular velocity equal to zero. In another example, the sensor 66 may generate an indication of movement of a top half 62 and/or a bottom half 64 of the foldable electronic display 12. If the foldable electronic display is being folded or unfolded, then the indication may include detected movement.

At block 226, a determination of the sensor data being indicative of a folding event or unfolding event may be made. For example, processing circuitry may determine if the sensor data is indicative of movement of the foldable electronic display 12. If the sensor data is indicative of movement, then the processing circuitry may determine that the sensor data is indicative of a display strain transition event. If the processing circuitry does not identify movement within the sensor data, then the processing circuitry may determine that a display strain transition event may not be occurring. In other words, the processing circuitry may determine that the foldable electronic display 12 is in an initial state.

If the indication is not indicative of a display strain transition event, then the method may return to block 222 to display image content at a frame rate and block 224 to receive an indication from the sensor 66. For example, the processing circuitry may instruct the foldable electronic display 12 to display image content at the frame rate.

If the indication is indicative of a folding event or unfolding event, at block 228, the image content may be displayed at an increased frame rate. For example, the foldable electronic display 12 may display image content during a period of time using an increased refresh rate (e.g., second refresh rate). The increased refresh rate may be any suitable refresh rate greater than the refresh rate used in block 222 to display image content. In other words, the foldable electronic display 12 may bound the refresh rate with a higher refresh rate by inserting multiple frames during the period of time. As such, image content being displayed may be refreshed at an increased refresh rate, which may compensate for the shifting threshold voltages of the transistors. Accordingly, the foldable electronic display 12 may display image content using a temporarily increased refresh rate.

After the period of time, the foldable electronic display 12 may sequence down the increased refresh rate. For example, the processing circuitry may taper (e.g., sequence) the refresh rate from the increased refresh rate down to a lower refresh rate. For example, the refresh rate may be tapered from the higher refresh rate back down to the refresh rate used in block 222 to display image content. The processing circuitry may space out a timing of subsequent frames of image content. Additionally or alternatively, the processing circuitry may walkdown the frequency at which subsequent frames may be displayed. A period of time of the walkdown may be determined by the processing circuitry (via the image data), calibrated according to display panel characteristics, or the like. The walkdown may occur over 1 period, 2 periods, 3 periods, and so on. For example, the walkdown may occur over 3 periods to allow for a smoother transition of image content from the current frame to the new frame. However, operating at higher refresh rates may cause the foldable electronic display 12 to consume more power. In another example, if the current frame and the new frame are not substantially different, the walkdown may occur over 1 period in order to save power.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic device comprising:
an electronic display configured to display frames of image data; and
processing circuitry configured to:
determine a display strain transition event of the electronic display; and
change a refresh rate of the electronic display based on the determination of the display strain transition event.

2. The electronic device of claim 1, wherein the processing circuitry is configured to determine the display strain transition event based on an unfolding of the electronic display.

3. The electronic device of claim 1, wherein the processing circuitry is configured to determine the display strain transition event based on a folding of the electronic display.

4. The electronic device of claim 1, wherein the processing circuitry is configured to change the refresh rate through frame insertion and frame rate sequencing of image frames at a higher frame rate.

5. The electronic device of claim 1, wherein the processing circuitry is configured to change the refresh rate to an increased refresh rate based on the determination of the display strain transition event.

6. The electronic device of claim 5, wherein the processing circuitry is configured to change the refresh rate back after the display strain transition event.

7. The electronic device of claim 6, wherein the processing circuitry is configured to change the refresh rate back over multiple image frames.

8. The electronic device of claim 1, comprising a sensor configured to detect an indication of the display strain transition event of the electronic display.

9. The electronic device of claim 8, wherein the sensor comprises an angular sensor.

10. The electronic device of claim 9, wherein the sensor is configured to detect a folding angle and an angular momentum.

11. A non-transitory computer-readable medium storing instructions that, when executed by a processor, cause the processor to:
receive sensor data indicative of a display strain transition event of an electronic display; and
adjust a refresh rate of image content displayed on the electronic display based on the indication of the display strain transition event.

12. The non-transitory computer-readable medium of claim 11, wherein adjusting the refresh rate of the image content comprises:
increasing the refresh rate of the image content based on the display strain transition event comprising the electronic display transitioning from a fully folded state to a fully unfolded state.

13. The non-transitory computer-readable medium of claim 12, comprising sequencing down the increased refresh rate to a lower refresh rate over multiple frames in response to completion of the display strain transition event.

14. The non-transitory computer-readable medium of claim 12, comprising changing the refresh rate back in response to completion of the display strain transition event.

15. The non-transitory computer-readable medium of claim 11, comprising maintaining the refresh rate based on the display strain transition event comprising the electronic display in an initial state.

16. A method comprising:
receiving, via processing circuitry, sensor data indicative of a display strain transition event of an electronic display;
determining, via the processing circuitry, the display strain transition event based on the sensor data; and
adjusting, via the processing circuitry, a refresh rate of image content displayed on the electronic display based on the determination.

17. The method of claim 16, wherein adjusting, via the processing circuitry, the refresh rate of the image content displayed on the electronic display comprises:
increasing the refresh rate over a period of time based on determining the display strain transition event is indicative of transitioning the electronic display from a folded state to an unfolded state.

18. The method of claim 17, comprising after the period of time, sequencing down the increased refresh rate to a lower refresh rate.

19. The method of claim 18, wherein the lower refresh rate is the same as the refresh rate.

20. The method of claim 18, wherein the lower refresh rate is different from the refresh rate.
